(19) United States
(12) Patent Application Publication
(10) Pub. No.: US 2026/0147463 A1
(43) Pub. Date: May 28, 2026

(54) ADJUSTING COLOR PARAMETERS USING AN INTEGRATED COLOR-CONTROL INTERFACE

(71) Applicant: Adobe Inc., San Jose, CA (US)

(72) Inventors: Benjamin Smith, Seattle, WA (US); Yaniv De Ridder, San Francisco, CA (US); William Ruby, San Francisco, CA (US); Benjamin Farrell, Hayward, CA (US); Alexis Van Hurkman, St. Paul, MN (US)

(21) Appl. No.: 18/958,162

(22) Filed: Nov. 25, 2024

(51) Int. Cl. G06F 3/04845; G06F 3/04847; G06T 5/90

(52) U.S. Cl. CPC G06F 3/04845; G06F 3/04847; G06T 5/90; G06T 2200/24; G06T 2207/10016; G06T 2207/10024; G06T 2207/20092

(57) ABSTRACT

Disclosed embodiments may provide techniques for adjusting color parameters using an integrated color-control interface. A computer-implemented method includes generating an integrated color-control interface for a first color parameter and a second color parameter. In some instances, the integrated color-control interface includes a visual-feedback indicator that conveys color distribution of pixels of an image. The method also includes receiving a gesture-based interaction within the integrated color-control interface. The gesture-based interaction includes using one or more gestures to adjust the first color parameter, the second color parameter, or both. The method also includes transforming the image in accordance with the adjusted first and second color parameters. The method also includes updating the integrated color-control interface by modifying the visual-feedback indicator, in which the visual-feedback indicator is modified to convey changes to the color distribution of the pixels as a result of performing the gesture-based interaction.

### FIELD

The present disclosure relates generally to modifying various color parameters of images and videos. In one example, the systems and methods described herein include a graphical user interface for adjusting color parameters having an interdependent color relationship.

### BACKGROUND

Image-editing applications provide a wide range of graphical user-interface features that allow users to enhance, manipulate, and transform digital images. For example, an image-editing application can facilitate color correction of images, in which brightness, contrast, saturation, and color balance of the images can be modified to enhance their overall visual appearance. In addition, the image-editing applications also provide cropping, resizing, and rotating images to fit specific dimensions or orientations. Other example features include removing unwanted artifacts and applying filters or effects to create artistic styles. These applications are widely used in photography, graphic design, and video production to generate high-quality visual content.

Color parameters define how colors are represented in an image. Example color parameters can include hue for determining the base color, and saturation for determining the intensity or vividness of such base color. Brightness or luminance is another color parameter that affects the overall lightness or darkness of the image, while contrast adjusts the difference between the darkest and lightest areas, making details more or less defined. Color temperature is another color parameter that shifts the image along a warm (orange) or cool (blue) spectrum, affecting the overall mood. Tint is a color parameter that adjusts the balance between green and magenta tones to correct subtle color casts. These different types of color parameters can be adjusted to define the visual appearance of the image, creating a balance between natural tones, exposure, and contrast to achieve the intended look or style.

### SUMMARY

Disclosed embodiments may provide an integrated color-control interface for simultaneously adjusting various types of color parameters. The integrated color-control interface can facilitate simultaneous adjustments to color parameters having interdependent color relationship, such as contrast/pivot and tint/temperature. By integrating these adjustments into a single, gesture-based interface, users can more easily modify image parameters without causing unintended changes or image artifacts.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 illustrates an example screenshot of an integrated color-control interface 100 for modifying different color parameters of an image, according to some embodiments.

FIG. 2 shows various types of integrated color-control interfaces for adjusting color parameters having an interdependent color relationship, according to some embodiments.

FIG. 3 shows a schematic diagram of a computing environment for adjusting color parameters using an integrated color-control interface, in accordance with some embodiments.

FIG. 4 shows an illustrative example of a process for adjusting color parameters using an integrated color-control interface, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Existing techniques manage controls of various color parameters, buts without considering interdependent relationships associated with some of these color parameters. Individual adjustments of color parameters that may have the interdependent relationship can lead to unintended changes to the image. For example, existing image-editing software programs only include interfaces for controlling contrast and pivot parameters individually (e.g., numerical value changes). Individual adjustments of the pivot and contrast parameters without a proper understanding of their interdependent relationship can result in undesirable effects, such as overly dark shadows or blown-out highlights in a corresponding image. Accordingly, it is challenging to simultaneously adjust multiple color parameters to achieve a target outcome for modifying colors of the image.

To address the aforementioned deficiencies, the present techniques provide integrated interface controls for simultaneously adjusting these interdependent color parameters, enabling users to make adjustments more fluidly and efficiently. A content-editing application generates an integrated color-control interface for a first color parameter and a second color parameter. The first and second color parameters are associated with an interdependent color relationship. The integrated color-control interface can be displayed with the image on the graphical user interface, which facilitates adjustment of the respective color parameters by a user. As an illustrative example, the content-editing application accesses an image of a person standing on a platform of a subway station during sunset. The content-editing application generates, for the image, the integrated color-control interface for pivot parameter and contrast parameter. The image and the integrated color-control interface can be displayed on the graphical user interface.

In some instances, the integrated color-control interface includes a visual-feedback indicator that conveys color distribution of pixels of an image. Continuing with the example, the visual-feedback indicator is a waveform graph that conveys distribution of luminance values of colors depicted in the image (e.g., yellow and orange colors for the sunset, gray color for showing the platform of the subway station).

The content-editing application receives a gesture-based interaction within the integrated color-control interface. In some instances, the gesture-based interaction includes using one or more gestures to adjust one of the first color parameter (e.g., the pivot parameter) or the second color parameter (e.g., the contrast parameter). Continuing with the example, the user can interact with the integrated color-control interface by: (i) dragging a pivot “line” across a y-dimension of the integrated color-control interface to adjust the pivot of the image; and (ii) pressing arrow keys of a keyboard to increase or decrease contrast value to adjust the contrast of the image relative to the adjusted pivot.

The content-editing application transforms the image in accordance with the adjusted first and second color parameters. Continuing with the example, the content-editing application identifies a first image region above the position of the pivot line and a second image region below the position of the user-interface element. Once these image regions are identified, the content-editing application differentially modifies contrast values of the image based on changes to the contrast parameter. Continuing with the example, increasing contrast results in updating luminance values of the first image region to appear brighter, while updating luminance values of the second image region to appear darker.

The content-editing application dynamically updates the integrated color-control interface by modifying the visual-feedback indicator. Continuing with the example, the content-editing application changes the distribution of luminance values of the waveform graph in accordance with the modified contrast values. The content-editing application facilitates display of the integrated color-control interface with the modified visual-feedback indicator. Continuing with the example, the graphical user interface displays the transformed image and the color-control interface to show how the adjusted pivot and contrast parameters affect the color properties of the image.

The present techniques thus provide a significant improvement over existing content-editing tools by merging advanced color-correction capabilities with a user-friendly design. The present techniques not only reduce the complexity associated with the interdependent relationships of various color parameters but also decrease the time needed for adjusting colors within an image or video. In addition, the present techniques implement gesture-based controls that can be adapted to various types of computing devices (e.g., tablets, smartphones) and make it easier to precisely control the color parameters. The increased usability can ultimately expand creative possibilities for users of varying image-editing skill levels.

### I. TECHNIQUES FOR ADJUSTING COLOR PARAMETERS USING AN INTEGRATED COLOR-CONTROL INTERFACE

### A. Example Implementation

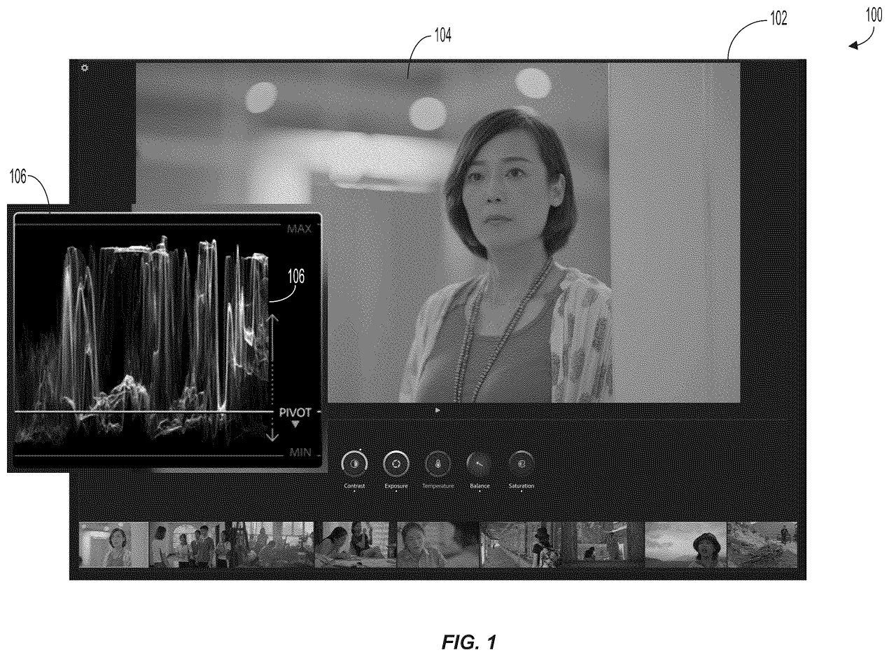

FIG. 1 illustrates an example screenshot 100 of an integrated color-control interface for modifying different color parameters of an image, according to some embodiments. As shown in FIG. 1, a graphical user interface 102 displays an image 104 and an integrated color-control interface 106 configured to provide simultaneous adjustments to multiple color parameters (e.g., tint/temperature, pivot/contrast) having an interdependent color relationship.

For example, the integrated color-control interface 106 shows a pivot parameter 108 that identifies which regions of the image 104 (e.g., highlights, shadows) should be more affected by subsequent contrast adjustments. A user can use various types of gestures to adjust pivot or contrast parameters shown on the integrated color-control interface 106. An example gesture can include dragging a pivot “line” across a y-dimension of the integrated color-control interface 106 to adjust the pivot of the image 104. Another example gesture can include using arrow keys of a keyboard to increase or decrease contrast value to adjust the contrast of the image relative to the adjusted pivot. In some instances, the integrated color-control interface 106 displays a visual-feedback indicator 108 (e.g., a waveform graph) that shows a distribution of luminance of pixels of the image 104. Adjustments to the contrast relative to the pivot line can immediately and dynamically update the luminance shown by the visual-feedback indicator 108. As a result of the adjustments, the graphical user interface 102 shows an updated image that is modified and transformed based on the adjusted color parameters that have an interdependent color relationship. The integrated color-control interface 106 thus implements visual-feedback indicators such as waveform graphs and overlaid arrows. The visual indicators show the effects of adjustments in real-time, providing immediate feedback that helps users understand how their interactions are altering the image. In some instances, the integrated color-control interface 106 shows directional elements (e.g., overlaid arrows) that indicate the magnitudes of the contrast changes for different regions of the image.

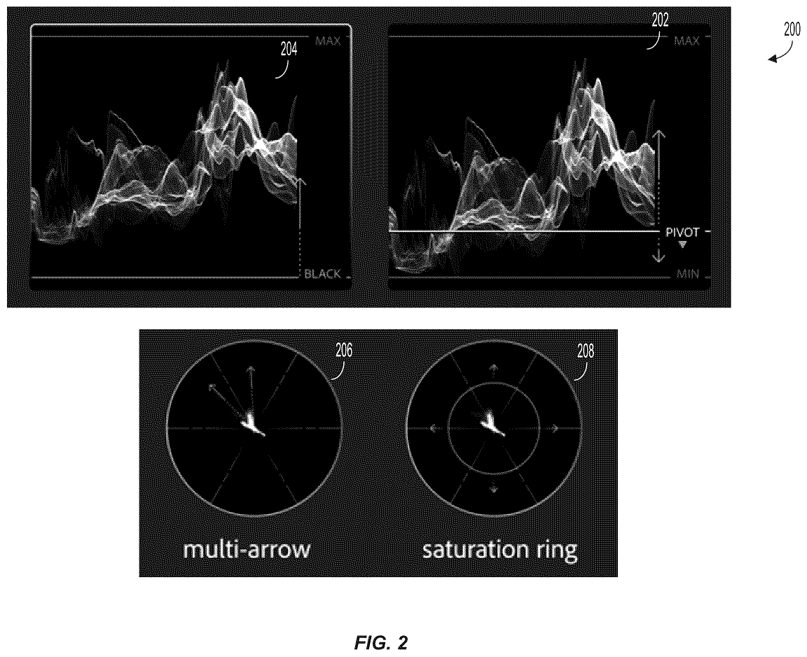

FIG. 2 shows various types of integrated color-control interfaces 200 for adjusting color parameters having an interdependent color relationship, according to some embodiments. For example, integrated color-control interfaces 202 and 204 incorporate waveform graphs and horizontal lines to simultaneously adjust multiple color parameters (e.g., pivot and contrast, black and contrast). In another example, tint and temperature parameters can be adjusted using integrated color-control interfaces 206 and 208 that incorporate color wheels and multiple arrows. As described herein, temperature typically controls the balance between warm (yellow/orange) and cool (blue) hues, while tint adjusts the balance between green and magenta hues. Since these two parameters affect the overall color balance, these color parameters demonstrate an interdependent color relationship, in which changing one temperature parameter often requires adjusting the tint parameter to maintain a consistent color impression. By using the integrated color-control interfaces 206 and 208, a user can modify both temperature and tint simultaneously by dragging the arrows to a particular x-y coordinate within the color wheel. The gestures can result in automatically adjusting both temperature and tint parameters, such that the color transformation of the image is less awkward and more natural.

### B. Computing Environment

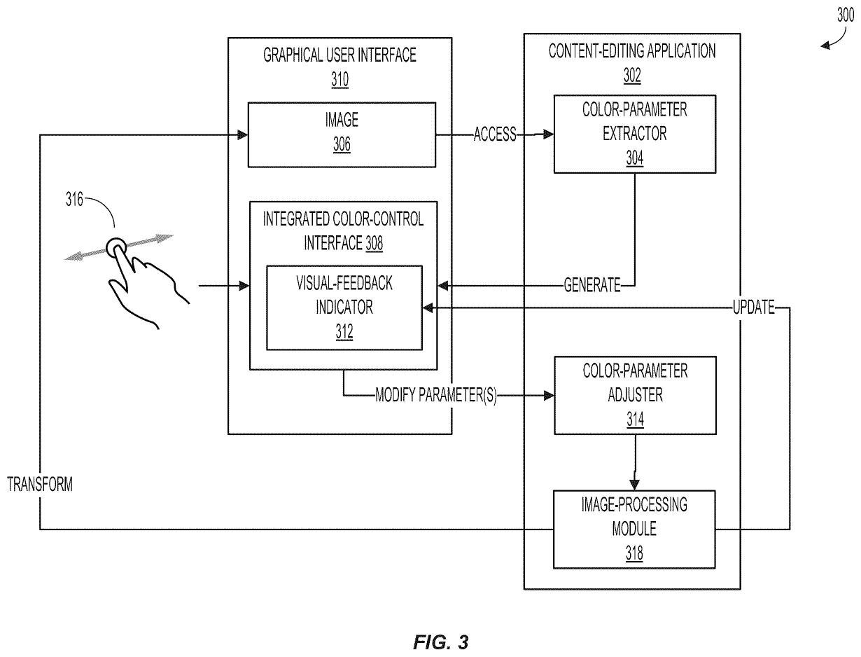

FIG. 3 shows a schematic diagram of a computing environment 300 for adjusting color parameters using an integrated color-control interface, in accordance with some embodiments. As shown in FIG. 3, a color-parameter extractor 304 of a content-editing application 302 access an image 306 and generates an integrated color-control interface 308 for a first color parameter and a second color parameter associated with the image 306. The first and second color parameters are configured to adjust color properties of the image 306 displayed on a graphical user interface 310. The image 306 includes a visual representation of a scene or an object captured by a camera device (e.g., a smartphone camera, video recorder). The image 306 includes a matrix of pixels, in which each pixel identifies color (e.g., RGB values) and intensity information. The image 306 can be a video frame of a plurality of video frames. For example, the image 306 can be a live-preview image of a particular video frame that is presented on the graphical user interface. Any modifications to the live-preview image can be performed and saved. Once saved, the modifications to the particular video frame can propagate to other video frames, either through batch processing, scene-wide adjustments, or automated propagation based on predefined settings. In some instances, the image 306 can be encoded in file formats such as JPEG, PNG, or TIFF. The image 306 can also be associated with metadata that identifies additional information about how or when the image 306 was captured.

The first and second color parameters are associated with an interdependent color relationship. When color parameters have an interdependent relationship, it provides that changes to one color parameter directly influence the effect or behavior of the other color parameter. For example, in the context of contrast adjustment, the pivot parameter acts as the reference point around which the contrast is applied. Increasing contrast makes values further from the pivot either brighter or darker, depending on whether they are above or below the pivot value. The contrast adjustment is thus dependent on the pivot parameter and thus demonstrates the interdependent color relationship. Examples of color parameters having the interdependent color relationship include: (i) pivot and contrast; (ii) tint and temperature; (iii) brightness and contrast; (iv) hue and saturation; (v) color balance and temperature; and (vi) contrast and exposure.

The integrated color-control interface 308 is displayed with the image 306 on the graphical user interface 310 of a user device (not shown), which facilitates adjustment of the respective color parameters by a user. In some instances, the integrated color-control interface 308 includes a visual-feedback indicator 312 that conveys color distribution of pixels of an image. For example, the visual-feedback indicator 312 is a waveform graph that conveys distribution of brightness or luminance values of pixels along the vertical or horizontal axis, providing insight into how evenly brightness is spread across the image 306. Other examples of the visual-feedback indicator include: (i) a color wheel; (ii) a color histogram; (iii) a vector scope; (iv) a color heatmap; and (v) a three-dimensional color space plot.

For example, if the first color parameter is a temperature parameter and the second color parameter is a tint parameter, the visual-feedback indicator 312 shows: (i) a first directional element that indicates a first magnitude of the adjustments to the temperature parameter; and (ii) a second directional element that indicates a second magnitude of the adjustments to the tint parameter.

A color-parameter adjuster 314 of the content-editing application 302 receives a gesture-based interaction 316 within the integrated color-control interface 308. In some instances, the gesture-based interaction 316 includes using one or more gestures to adjust one of the first color parameter (e.g., the pivot parameter) or the second color parameter (e.g., the contrast parameter). In some instances, the adjustment of the first color parameter can trigger updating the second color parameter according to their interdependent color relationship. When the one or more gestures include dragging a cursor to a particular location within the integrated color-control interface, the color-parameter adjuster 314 adjusts the first and second color parameters according to x-y coordinates of the particular location.

The one or more gestures include dragging a user-interface element (e.g., using a drag gesture with one or more fingers on a touchscreen, click and drag with a mouse) across a y-axis of the integrated color-control interface, in which the user-interface element is associated with the first color parameter. Other examples of the gestures can include click, double-click, right-click, drag, drop, hover, scroll, swipe, pinch, zoom, tap, double-tap, press and hold, rotate, pan, flick, two-finger scroll, three-finger swipe, four-finger tap, spread, and long press.

Continuing with FIG. 3, an image-processing module 318 of the content-editing application 302 transforms the image in accordance with the adjusted first and second color parameters. For example, with respect to the pivot and contrast parameters, the image-processing module 318 identifies a first image region and a second image region based on adjustments to the pivot parameter. In some instances, the first image region can be identified above the position of the user-interface element (e.g., a pivot line) that represents the pivot parameter, and the second image region can be identified below the position of the user-interface element. Once these image regions are identified, the image-processing module 318 differentially modifies contrast values of the image based on changes to the contrast parameter. Specifically, to update the contrast based on the adjusted pivot parameter, each pixel's intensity is initially adjusted relative to the pivot value, then the contrast factor is applied to update the pixel values to reflect the updated contrast (as shown in the formula below):
New Pixel Intensity Value=(Old Pixel Intensity Value−Pivot)×Contrast Factor+Pivot

The Old Pixel Intensity Value corresponds to the original intensity value of the pixel (e.g., in the range [0, 255] for an 8-bit image). The Pivot corresponds to the pivot parameter around which the contrast is adjusted. The pivot parameter can be the mid-point of the intensity range (e.g., 128 for an 8-bit image), or any specific value selected based on the adjusted pivot parameter. The Contrast Factor corresponds to a multiplier that determines how much contrast is increased or decreased. Values greater than 1 increase contrast, while values between 0 and 1 decrease contrast. Based on the formula above, contrast values corresponding to the first image region are adjusted at a different magnitude from contrast values that correspond to the second image region.

After transforming the image, the image-processing module 318 dynamically updates the integrated color-control interface 308 by modifying the visual-feedback indicator 312. In some instances, the visual-feedback indicator 312 is modified to convey changes to the color distribution of the pixels as a result of performing the gesture-based interaction 316. For example, if the visual-feedback indicator 312 is a waveform graph, the image-processing module 318 changes the luminance values of the waveform graph in accordance with the modified contrast values.

The graphical user interface 310 then displays the transformed image and the integrated color-control interface 308 with the modified visual-feedback indicator 312. If the image corresponds to a video frame of a plurality of video frames, the image-processing module 318 propagates the adjusted first and second color parameters to transform other video frames of the plurality of video frames.

### C. Methods

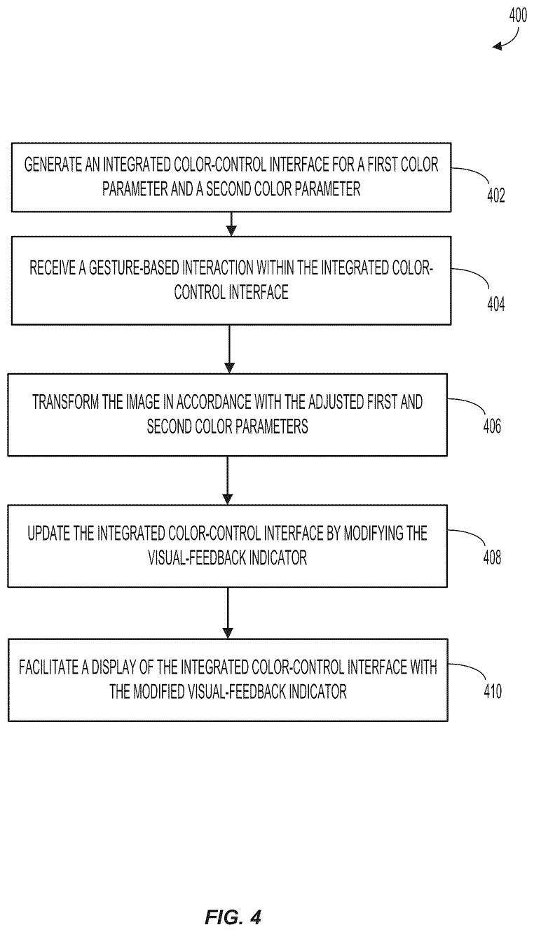

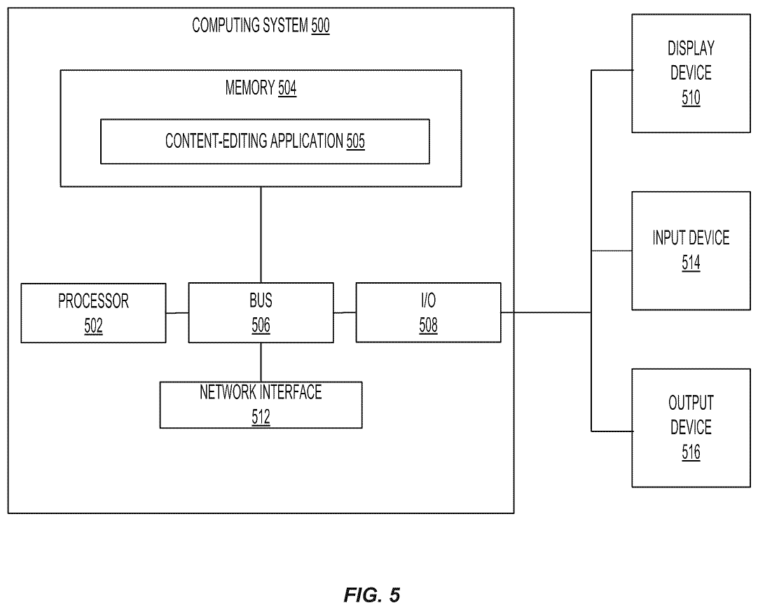

FIG. 4 shows an illustrative example of a process 400 for adjusting color parameters using an integrated color-control interface, in accordance with some embodiments. For illustrative purposes, the process 400 is described with reference to the components illustrated in FIG. 3, though other implementations are possible. For example, the program code for the content-editing application 302 of FIG. 3, is executed by one or more processing devices to cause a server system (e.g., the computing device 502 of FIG. 5) to perform one or more operations described herein.

At step 402, the content-editing application generates an integrated color-control interface for a first color parameter and a second color parameter. The first and second color parameters are configured to adjust color properties of a given image displayed on a graphical user interface. The image can be a video frame of a plurality of video frames. For example, the image can be a live-preview image of a particular video frame that is presented on the graphical user interface. Any modifications to the live-preview image can be performed and saved. Once saved, the modifications to the particular video frame can propagate to other video frames, either through batch processing, scene-wide adjustments, or automated propagation based on predefined settings. In some instances, the image can be encoded in file formats such as JPEG, PNG, or TIFF. The image can also be associated with metadata that identifies additional information about how or when the image was captured.

The first and second color parameters are associated with an interdependent color relationship. For example, the first color parameter is a pivot parameter, and the second color parameter is a contrast parameter. The integrated color-control interface is displayed with the image on the graphical user interface, which facilitates adjustment of the respective color parameters by a user. In some instances, the integrated color-control interface includes a visual-feedback indicator that conveys color distribution of pixels of an image. For example, the visual-feedback indicator is a waveform graph that conveys distribution of luminance values of colors depicted in the image.

As an illustrative example of the integrated color-control interface, if the first color parameter is a temperature parameter and the second color parameter is a tint parameter, the visual-feedback indicator of the integrated color-control interface includes: (i) a first directional element that indicates a first magnitude of the adjustments to the temperature parameter; and (ii) a second directional element that indicates a second magnitude of the adjustments to the tint parameter.

At step 404, the content-editing application receives a gesture-based interaction within the integrated color-control interface. In some instances, the gesture-based interaction includes using one or more gestures to adjust one of the first color parameter (e.g., the pivot parameter) or the second color parameter (e.g., the contrast parameter). The adjustment of the first color parameter can trigger updating the second color parameter according to their interdependent color relationship. For example, when the one or more gestures include dragging a cursor to a particular location within the integrated color-control interface, the content-editing application adjusts the first and second color parameters according to x-y coordinates of the particular location.

The one or more gestures include dragging a user-interface element (e.g., using a drag gesture with one or more fingers on a touchscreen, click and drag with a mouse) across a y-axis of the integrated color-control interface, in which the user-interface element is associated with the first color parameter. Other examples of the gestures can include click, double-click, right-click, drag, drop, hover, scroll, swipe, pinch, zoom, tap, double-tap, press and hold, rotate, pan, flick, two-finger scroll, three-finger swipe, four-finger tap, spread, and long press.

At step 406, the content-editing application transforms the image in accordance with the adjusted first and second color parameters. For example, with respect to the pivot and contrast parameters, the content-editing application identifies a first image region and a second image region based on adjustments to the pivot parameter. In some instances, the first image region can be identified above the position of the user-interface element that represents the pivot parameter, and the second image region can be identified below the position of the user-interface element. Once these image regions are identified, the content-editing application differentially modifies contrast values of the image based on changes to the contrast parameter. Specifically, to update the contrast based on the adjusted pivot parameter, each pixel's intensity is initially adjusted relative to the pivot value, then the contrast factor is applied to update the pixel values to reflect the updated contrast.

At step 408, the content-editing application updates the integrated color-control interface by modifying the visual-feedback indicator. In some instances, the visual-feedback indicator is modified to convey changes to the color distribution of the pixels as a result of performing the gesture-based interaction. For example, if the visual-feedback indicator is a waveform graph, the content-editing application changes the luminance values of the waveform graph in accordance with the modified contrast values.

At step 410, the content-editing application facilitates display of the integrated color-control interface with the modified visual-feedback indicator. In some instances, the graphical user interface displays the transformed image and the color-control interface to show how the adjusted parameters affect the color properties of the image. If the image corresponds to a video frame of a plurality of video frames, the content-editing application propagates the adjusted first and second color parameters to transform other video frames of the plurality of video frames. Process 400 terminates thereafter. II. EXAMPLE SYSTEMS

Any suitable computing system or group of computing systems can be used for performing the operations described herein. For example, FIG. 5 depicts a computing system 500 that can implement any of the computing systems or environments discussed above. In some embodiments, the computing system 500 includes a processing device 502 that executes the content-editing application 505, a memory that stores various data computed or used by the content-editing application 505, an input device 514 (e.g., a mouse, a stylus, a touchpad, a touch-screen, etc.), and an output device 516 that presents output to a user (e.g., a display device that displays graphical content generated by content-editing application 505). For illustrative purposes, FIG. 5 depicts a single computing system on which the content-editing application 505 is executed, and the input device 514 and output device 516 are present. But these applications, datasets, and devices can be stored or included across different computing systems having devices similar to the devices depicted in FIG. 5.

The example of FIG. 5 includes a processing device 502 communicatively coupled to one or more memory devices 504. The processing device 502 executes computer-executable program code stored in a memory device 504, accesses information stored in the memory device 504, or both. Examples of the processing device 502 include a microprocessor, an application-specific integrated circuit (“ASIC”), a field-programmable gate array (“FPGA”), or any other suitable processing device. The processing device 502 can include any number of processing devices, including a single processing device.

The memory device 504 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C #, Visual Basic, Java, Python, Perl, JavaScript, and ActionScript.

The computing system 500 could also include a number of external or internal devices, such as a display device 510, or other input or output devices. For example, the computing system 500 is shown with one or more input/output (“I/O”) interfaces 508. An I/O interface 508 can receive input from input devices or provide output to output devices. One or more buses 506 are also included in the computing system 500. Each bus 506 communicatively couples one or more components of the computing system 500 to each other or to an external component.

The computing system 500 executes program code that configures the processing device 502 to perform one or more of the operations described herein. The program code includes, for example, code implementing the document-processing application 102 or other suitable applications that perform one or more operations described herein. The program code can be resident in the memory device 504 or any suitable computer-readable medium and can be executed by the processing device 502 or any other suitable processor. In some embodiments, all modules in the content-editing application 505 are stored in the memory device 504, as depicted in FIG. 5. In additional or alternative embodiments, one or more of these modules from the content-editing application 505 are stored in different memory devices of different computing systems.

In some embodiments, the computing system 500 also includes a network interface device 512. The network interface device 512 includes any device or group of devices suitable for establishing a wired or wireless data connection to one or more data networks. Non-limiting examples of the network interface device 512 include an Ethernet network adapter, a modem, and/or the like. The computing system 500 is able to communicate with one or more other computing devices (e.g., a computing device that receives inputs for document-processing application 102 or displays outputs of the document-processing application 102) via a data network using the network interface device 512.

An input device 514 can include any device or group of devices suitable for receiving visual, auditory, or other suitable input that controls or affects the operations of the processing device 502. Non-limiting examples of the input device 514 include a touchscreen, stylus, a mouse, a keyboard, a microphone, a separate mobile computing device, etc. An output device 516 can include any device or group of devices suitable for providing visual, auditory, or other suitable sensory output. Non-limiting examples of the output device 516 include a touchscreen, a monitor, a separate mobile computing device, etc.

Although FIG. 5 depicts the input device 514 and the output device 516 as being local to the computing device that executes the document-processing application 102, other implementations are possible. For instance, in some embodiments, one or more of the input device 514 and the output device 516 include a remote client-computing device that communicates with the computing system 500 via the network interface device 512 using one or more data networks described herein.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method comprising:
generating an integrated color-control interface for a first color parameter and a second color parameter, wherein the integrated color-control interface includes a visual-feedback indicator that conveys color distribution of pixels of an image;
receiving a gesture-based interaction within the integrated color-control interface, wherein the gesture-based interaction includes using one or more gestures to adjust the first color parameter, the second color parameter, or both;
transforming the image in accordance with the adjusted first and second color parameters;
updating the integrated color-control interface by modifying the visual-feedback indicator, wherein the visual-feedback indicator is modified to convey changes to the color distribution of the pixels as a result of performing the gesture-based interaction; and
facilitating a display of the integrated color-control interface with the modified visual-feedback indicator.

2. The method of claim 1, wherein the first color parameter is a pivot parameter and the second color parameter is a contrast parameter, and wherein transforming the image includes:
identifying a first image region and a second image region based on adjustments to the pivot parameter; and
modifying contrast values of the image based on adjustments to the contrast parameter, wherein a first set of the contrast values corresponding to the first image region are adjusted at a first magnitude, wherein a second set of the contrast values corresponding to the second image region are adjusted at a second magnitude, and wherein the first magnitude is different from the second magnitude.

3. The method of claim 2, wherein the visual-feedback indicator is a waveform graph that conveys distribution of luminance values of colors depicted in the image, and wherein modifying the visual-feedback indicator includes changing the luminance values in accordance with the modified contrast values.

4. The method of claim 1, wherein the first color parameter is a temperature parameter and the second color parameter is a tint parameter, and wherein the visual-feedback indicator includes: (i) a first directional element that indicates a first magnitude of adjustments to the temperature parameter; and (ii) a second directional element that indicates a second magnitude of adjustments to the tint parameter.

5. The method of claim 1, wherein the image corresponds to a video frame of a plurality of video frames, the method further comprising propagating the adjusted first and second color parameters to transform other video frames of the plurality of video frames.

6. The method of claim 1, wherein the one or more gestures include dragging a user-interface element across a first dimension of the integrated color-control interface, and wherein the user-interface element is associated with the first color parameter.

7. The method of claim 1, wherein the one or more gestures include dragging a cursor to a particular location within the integrated color-control interface, and wherein the first and second color parameters are adjusted according to x-y coordinates of the particular location.

8. A system comprising:
one or more processors; and
a non-transitory computer-readable medium storing instructions that when executed by the one or more processors, cause the one or more processors to perform operations including:
generating an integrated color-control interface for a pivot parameter and a contrast parameter, wherein the integrated color-control interface includes a visual-feedback indicator that conveys color distribution of pixels of an image;
receiving a gesture-based interaction within the integrated color-control interface, wherein the gesture-based interaction includes using one or more gestures to adjust the pivot parameter, the contrast parameter, or both;
transforming the image in accordance with the adjusted pivot and contrast parameters;
dynamically modifying the visual-feedback indicator to convey changes to the color distribution of the pixels as a result of the adjusted pivot and contrast parameters; and
facilitating a display of the integrated color-control interface with the modified visual-feedback indicator.

9. The system of claim 8, wherein transforming the image includes:
identifying a first image region and a second image region based on adjustments to the pivot parameter; and
modifying contrast values of the image based on adjustments to the contrast parameter, wherein a first set of the contrast values corresponding to the first image region are adjusted at a first magnitude, wherein a second set of the contrast values corresponding to the second image region are adjusted at a second magnitude, and wherein the first magnitude is different from the second magnitude.

10. The system of claim 9, wherein the visual-feedback indicator is a waveform graph that conveys distribution of luminance values of colors depicted in the image, and wherein modifying the visual-feedback indicator includes changing the luminance values in accordance with the modified contrast values.

11. The system of claim 8, wherein the image corresponds to a video frame of a plurality of video frames, and wherein the instructions further cause the one or more processors to perform operations comprising propagating the adjusted pivot and contrast parameters to transform other video frames of the plurality of video frames.

12. The system of claim 8, wherein the one or more gestures include dragging a user-interface element across a y-dimension of the integrated color-control interface, and wherein the user-interface element is associated with the pivot parameter.

13. A non-transitory computer-readable medium storing instructions that when executed by one or more processors, cause the one or more processors to perform operations including:
generating an integrated color-control interface for a first color parameter and a second color parameter, wherein the integrated color-control interface includes a visual-feedback indicator that conveys color distribution of pixels of an image;
receiving a gesture-based interaction within the integrated color-control interface, wherein the gesture-based interaction includes using one or more gestures to adjust the first color parameter, the second color parameter, or both;
transforming the image in accordance with the adjusted first and second color parameters;
updating the integrated color-control interface by modifying the visual-feedback indicator, wherein the visual-feedback indicator is modified to convey changes to the color distribution of the pixels as a result of performing the gesture-based interaction; and
facilitating a display of the integrated color-control interface with the modified visual-feedback indicator.

14. The non-transitory computer-readable medium of claim 13, wherein the first color parameter is a pivot parameter and the second color parameter is a contrast parameter, and wherein transforming the image includes:
identifying a first image region and a second image region based on adjustments to the pivot parameter; and
modifying contrast values of the image based on adjustments to the contrast parameter, wherein a first set of the contrast values corresponding to the first image region are adjusted at a first magnitude, wherein a second set of the contrast values corresponding to the second image region are adjusted at a second magnitude, and wherein the first magnitude is different from the second magnitude.

15. The non-transitory computer-readable medium of claim 14, wherein the visual-feedback indicator is a waveform graph that conveys distribution of luminance values of colors depicted in the image, and wherein modifying the visual-feedback indicator includes changing the luminance values in accordance with the modified contrast values.

16. The non-transitory computer-readable medium of claim 13, wherein the first color parameter is a temperature parameter and the second color parameter is a tint parameter, and wherein the visual-feedback indicator includes: (i) a first directional element that indicates a first magnitude of adjustments to the temperature parameter; and (ii) a second directional element that indicates a second magnitude of adjustments to the tint parameter.

17. The non-transitory computer-readable medium of claim 13, wherein the image corresponds to a video frame of a plurality of video frames, and wherein the instructions further cause the one or more processors to perform operations comprising propagating the adjusted first and second color parameters to transform other video frames of the plurality of video frames.

18. The non-transitory computer-readable medium of claim 13, wherein the one or more gestures include dragging a user-interface element across a first dimension of the integrated color-control interface, and wherein the user-interface element is associated with the first color parameter.

19. The non-transitory computer-readable medium of claim 13, wherein the one or more gestures include dragging a cursor to a particular location within the integrated color-control interface, and wherein the first and second color parameters are adjusted according to x-y coordinates of the particular location.
